(19) United States
(12) Patent Application Publication
(10) Pub. No.: US 2011/0050736 A1
(43) Pub. Date: Mar. 3, 2011

(54) PIXEL AND ILLUMINATING DEVICE THEREOF

(75) Inventors: Ching-Lin Fan, Keelung City (TW); Yu-Sheng Lin, Taoyuan County (TW); Bo-Sin Lin, Taipei County (TW); Hsiu-Chen Chang, Taipei City (TW); Yan-Wei Liu, Miaoli City (TW)

(73) Assignee: National Taiwan University of Science and Technology, Taipei (TW)

(21) Appl. No.: 12/702,301

(22) Filed: Feb. 9, 2010

(30) Foreign Application Priority Data
Sep. 1, 2009 (TW) 98129451

(51) Int. Cl. G06F 3/038; G09G 5/10

(52) U.S. Cl. 345/690; 345/213; 345/82

(57) ABSTRACT

A pixel and an illuminating device thereof are provided. The pixel includes an organic light emitting diode (OLED), a transistor, a first switch, a second switch and a capacitor. One end of the OLED is electrically connected to a first voltage. A first source/drain of the transistor is electrically connected to a first potential point. The first switch is electrically connected between a second source/drain of the transistor and a second potential point, and is controlled by a first driving signal. The second switch is electrically connected between the second source/drain of the transistor and a gate of the transistor, and is controlled by a second driving signal. The capacitor is electrically connected between the gate of the transistor and a data line. The first driving signal and the second driving signal are used to alternately enable/disable the first and the second switches, so as to drive the pixel.

### CROSS-REFERENCE TO RELATED APPLICATION

This application claims the priority benefit of Taiwan application serial no. 98129451, filed Sep. 1, 2009. The entirety of the above-mentioned patent application is hereby incorporated by reference herein and made a part of specification.

### BACKGROUND OF THE INVENTION

1. Field of the Invention

The present invention relates to a pixel structure, more particularly, to a pixel structure having an organic light-emitting diode (OLED) and application thereof.

2. Description of Related Art

With development of electronic technology, people's demand for visual service provided by consumable electronic product becomes higher. Regardless of conventional televisions or advanced personal computers and mobile phones, etc, quality for displayed images are highly required. Presently, the most popular display panels are liquid crystal display (LCD) panels. However, although technical development of the LCD panel has a high maturity, due to inherent limitations of liquid crystal materials, development of the LCD panel is bottlenecked, for example, increasing of a response speed of the LCD is bottlenecked. Therefore, various types of display panels (for example, an organic light-emitting diode (OLED) display panel) are continually researched and developed.

Generally, pixels in the OLED display panel can be implemented by P-type transistor structures of 2T1C (i.e. two transistors and one capacitor). However, in such type of the pixel, a current flowing through the OLED is not only changed as a system voltage Vdd is influenced by an IR drop, but can also be different as a threshold voltage of the transistor is shifted.

Another type of pixel implemented by an N-type transistor structure of 2T1C is provided. However, in such type of the pixel, current flowing through the OLED is not only changed as a threshold voltage of the transistor is shifted, but is also varied as a threshold voltage of the OLED device is shifted for long operation time.

### SUMMARY OF THE INVENTION

Accordingly, the present invention is directed to a pixel, in which brightness of an organic light-emitting diode (OLED) is not changed as a threshold voltage of a transistor used for driving the OLED is shifted.

The present invention is directed to an illuminating device, in which illuminating brightness of an OLED is not changed as a threshold voltage of a transistor used for driving the OLED is shifted.

The present invention is directed to another pixel, in which a phenomenon that brightness of an OLED of the pixel is changed as a system voltage is influenced by an IR drop can be mitigated.

The present invention is directed to still another pixel, in which a phenomenon that brightness of an OLED of the pixel is changed as a threshold voltage of the OLED is shifted can be mitigated.

The present invention provides a pixel including an OLED, a transistor, a first switch, a second switch and a capacitor. One end of the OLED is electrically connected to a first voltage. A first source/drain of the transistor is electrically connected to a first potential point. The first switch is electrically connected between a second source/drain of the transistor and a second potential point, and is controlled by a first driving signal. The second switch is electrically connected between the second source/drain of the transistor and a gate of the transistor, and is controlled by a second driving signal. The capacitor is electrically connected between the gate of the transistor and a data line. The first driving signal and the second driving signal are used to alternately enable/disable the first and the second switches, so as to drive the pixel.

In an embodiment of the present invention, the first driving potential point is another end of the OLED; the second potential point is a second voltage; the first driving signal is a light emitting enable signal; and the second driving signal is a compensation signal. In this case, when the compensation signal and the light-emitting enable signal simultaneously enable the second switch and the first switch, the gate of the transistor is pre-charged to a voltage closed to the second voltage. In an embodiment, a voltage of the data line is a low level voltage.

In an embodiment of the present invention, the first switch is a first transistor, and the second switch is a second transistor. In an embodiment, when the compensation signal and the light-emitting enable signal simultaneously enable the second transistor and the first transistor, the gate of the transistor is pre-charged to a voltage equal to the second voltage minus threshold voltages of the first and the second transistors. In an embodiment, a voltage of the data line is a low level voltage.

In an embodiment of the present invention, when the compensation signal enables the second switch and the light-emitting enable signal disables the first switch, the gate of the transistor is discharged to a voltage equal to a sum of a threshold voltage of the transistor and a threshold voltage of the OLED. In an embodiment, a voltage of the data line is a low level voltage.

In an embodiment of the present invention, when the compensation signal disables the second switch and the light-emitting enable signal enables the first switch, a voltage of the gate of the transistor is boosted to a voltage of the data line plus threshold voltages of the transistor and the OLED.

In an embodiment of the present invention, the transistor, the first switch and the second switch are N-type transistors.

In an embodiment of the present invention, the first potential point is a second voltage; the second potential point is another end of the OLED; the first driving signal is a first scan signal; and the second driving signal is a second scan signal. In this case, when the first scan signal disables the first switch and the second scan signal enables the second switch, a gate voltage of the transistor is equal to the second voltage minus a threshold voltage of the transistor.

In an embodiment of the present invention, when the first scan signal enables the first switch and the second scan signal disables the second switch, a gate voltage of the transistor is equal to the second voltage minus a threshold voltage of the transistor and a voltage of the data line formed when the first switch is disabled and the second switch is enabled.

In an embodiment of the present invention, the first scan signal is inverted to the second scan signal. In an embodiment, the transistor, the first switch and the second switch are P-type transistors.

In an embodiment of the present invention, the first scan signal is the same to the second scan signal. In an embodiment, the transistor and the first switch are P-type transistors, and the second switch is an N-type transistor.

In an embodiment of the present invention, the first voltage is a ground voltage, and the second voltage is a system voltage.

The present invention provides an illuminating device including at least a light-emitting unit, and the light-emitting unit includes the above pixel submitted by the present invention.

According to the pixel of the present invention and the driving method thereof, the brightness of the OLED in the pixel and the threshold voltage of the transistor used for driving the OLED are irrelevant, so that the brightness of the OLED is not changed as the threshold voltage of the transistor is shifted. Moreover, regarding the OLED, a phenomenon that the brightness of the OLED is changed as the threshold voltage thereof is shifted and a phenomenon that the brightness of the OLED is changed as the system voltage is influenced by the IR drop can be mitigated. In addition, the pixel of the present invention can also serve as a light-emitting unit for organic light-emitting illumination applications, and with functions of compensating inconsistency of the threshold voltage of the conventional transistor and attenuation of the OLED as the using time thereof increases, according to this patent, not only theses shortages can be compensated, but also illuminating brightness of the illuminating device can be adjusted according to different voltages.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an equivalent circuit diagram of a pixel according to a first embodiment of the present invention.

FIG. 1B is a drive timing diagram of a pixel according to a first embodiment of the present invention.

FIG. 1C is an equivalent circuit diagram of another pixel according to a first embodiment of the present invention.

FIG. 2A is a characteristic curve diagram of a current flowing through an OLED and a data voltage transmitted by a data line according to a first embodiment of the present invention.

FIG. 2B is an error rate diagram illustrated according to FIG. 2A.

FIG. 3 is a characteristic curve diagram of a current flowing through an OLED and a system voltage according to a first embodiment of the present invention.

FIG. 4 is a flowchart illustrating a driving method of a pixel according to a first embodiment of the present invention.

FIG. 5A is an equivalent circuit diagram of a pixel according to a second embodiment of the present invention.

FIG. 5B is a drive timing diagram of a pixel according to a second embodiment of the present invention.

FIG. 5C is a diagram illustrating a simulation result of voltage variation at an anode of an OLED according to a second embodiment of the present invention.

FIG. 6A is a characteristic curve diagram of currents flowing through OLEDs and a data voltage transmitted by a data line according to a second embodiment of the present invention.

FIG. 6B is another characteristic curve diagram of currents flowing through OLEDs and a data voltage transmitted by a data line according to a second embodiment of the present invention.

FIG. 7 is a flowchart illustrating a driving method of a pixel according to a second embodiment of the present invention.

### DESCRIPTION OF THE EMBODIMENTS

### First Embodiment

An embodiment is provided below for describing a pixel of the present invention, so as to fully convey the concept of the present invention to those skilled in the art.

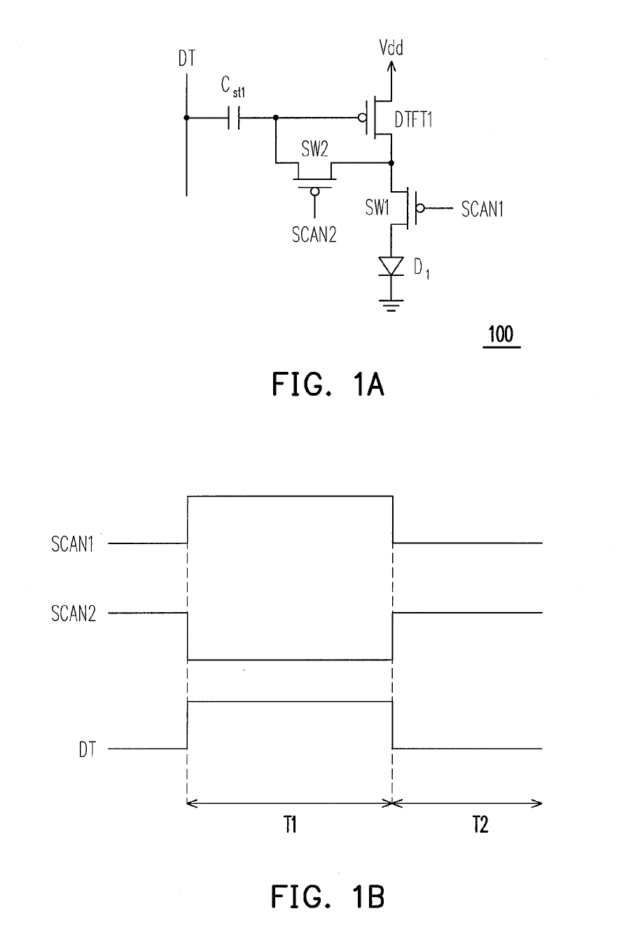

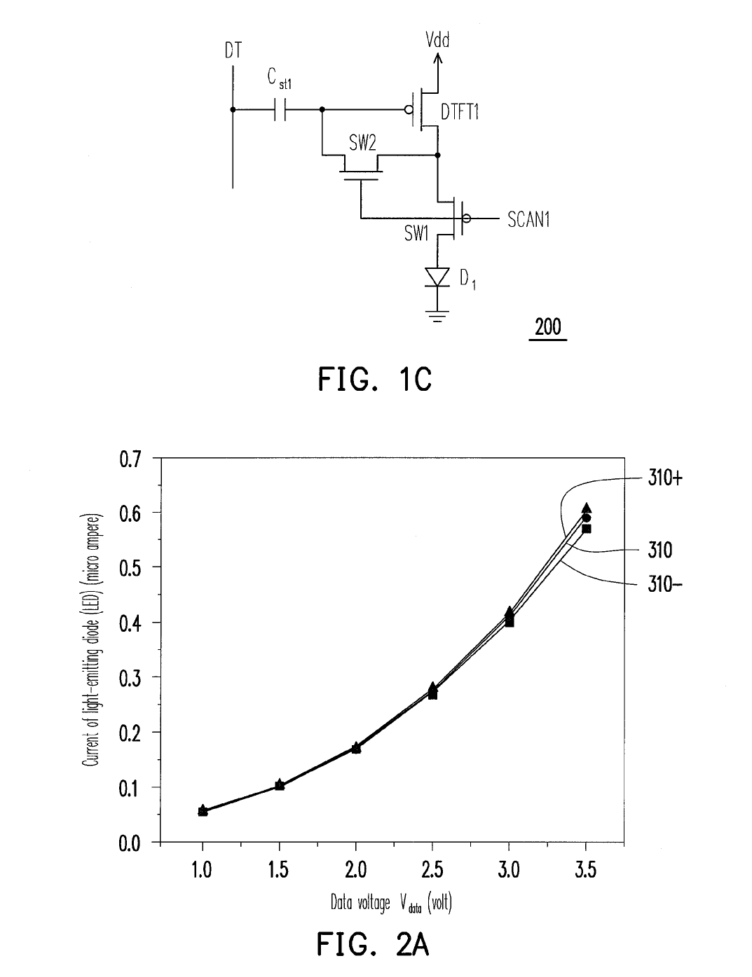

Referring to FIG. 1A, FIG. 1A is an equivalent circuit diagram of a pixel according to a first embodiment of the present invention. The pixel 100 of the present embodiment includes an organic light-emitting diode (OLED) D₁, a transistor DTFT1, a switch SW1, a switch SW2 and a capacitor Cₛₜ₁. In the present embodiment, the transistor DTFT1 is, for example, a P-type transistor, and the switches SW1 and SW2 are formed by transistors connected as switches.

A cathode of the OLED D₁ is electrically connected to a first voltage (which is a ground voltage GND in the present embodiment). A first source/drain of the transistor DTFT1 is electrically connected to a first potential point (for example, a second voltage, which is a system voltage Vdd in the present embodiment). The switch SW1 is electrically connected between a second source/drain of the transistor DTFT1 and a second potential point (for example, an anode of the OLED D₁), wherein the switch SW1 is controlled by a first driving signal, for example, a scan signal SCAN1. The switch SW2 is electrically connected between the second source/drain of the transistor DTFT1 and a gate of the transistor DTFT1, and is controlled by a second driving signal, for example, a scan signal SCAN2. The capacitor Cₛₜ₁ is electrically connected between the gate of the transistor DTFT1 and a data line DT.

Referring to FIG. 1B for operation of the pixel 100 of the first embodiment, and FIG. 1B is a drive timing diagram of the pixel according to the first embodiment of the present invention. It should be noticed that operation of the switch SW1 is inversed to that of the switch SW2, wherein the switches SW1 and SW2 are, for example, formed by P-type thin-film transistors. The switches SW1 and SW2 are enabled when control signals thereof have a low level, and are disabled when the control signals have a high level.

In the present embodiment, a driving time zone is mainly divided into two periods, and during a period T1, the scan signal SCAN1 has the high level and the scan signal SCAN2 has the low level, so that the switch SW1 is disabled and the switch SW2 is enabled, and the gate and the second source/drain of the transistor DTFT1 are mutually coupled to form a diode connection. Therefore, a path for the system voltage Vdd transmitting a current to the OLED D₁ is blocked since the switch SW1 is disabled, and the gate of the transistor DTFT1 is charged until a voltage thereof is equal to the system voltage Vdd minus a threshold voltage V_{TH, DTFT1} of the transistor DTFT1 since the switch SW2 is enabled, i.e. Vdd−|V_{TH, DTFT1}|. Meanwhile, the data line DT transmits data, so that the capacitor Cₛₜ₁ stores a data voltage V_{data} transmitted by the data line DT, and has a voltage difference of Vdd−|V_{TH, DTFT1}|−V_{data}.

Then, during a second period T2, the scan signal SCAN1 is transited to the low level, and the scan signal SCAN2 is transited to the high level, so that the switch SW1 is enabled and the switch SW2 is disabled. Therefore, the system voltage Vdd can drive the transistor DTFT1 to transmit a current to the OLED D₁ through the switch SW1, so as to light the OLED D₁. Meanwhile, the data voltage transmitted by the data line DT is decreased to 0V (volt), so that a gate voltage of the transistor DTFT1 is influenced by a capacitance effect of the capacitor Cₛₜ₁, and is pulled down to a voltage equal to the system voltage Vdd minus the threshold voltage V_{TH, DTFT1} of the transistor DTFT1 and the voltage V_{data} of the data line, i.e. Vdd−|V_{TH, DTFT1}|−V_{data}.

Since the transistor DTFT1 is maintained to a saturation area, a current I_{D1} flowing through the OLED D₁ is calculated according to a following equation:

$$\begin{matrix}{I}_{D 1} = \frac{1}{2} {{K}_{DTFT 1} ( {V}_{GS , DTFT 1} + \vert {V}_{TH , DTFT 1} \vert )}^{2} \\ = \frac{1}{2} {{K}_{DTFT 1} ( ( {V}_{dd} - \vert {V}_{TH , DTFT 1} \vert - {V}_{data} - {V}_{dd} ) + \vert {V}_{TH , DTFT 1} \vert )}^{2}\end{matrix} \qquad ( 1 )$$

Where I_{D1} is the current flowing through the OLED D₁ (i.e. I_{OLED1}), V_{GS, DTFT1} is a gate-source voltage of the transistor DTFT1, and K_{DTFT1} is a current constant of the transistor DTFT1. Moreover, the equation (1) can be further modified to be an equation (2):

$${I}_{D 1} = \frac{1}{2} {{K}_{DTFT 1} ( - {V}_{data} )}^{2} \qquad ( 2 )$$

According to the equations (1) and (2), it is known that the gate-source voltage V_{GS, DTFT1} of the transistor DTFT1 does not contain a parameter of the system voltage Vdd, so that a situation that the current I_{D1} (i.e. I_{OLED1}) flowing through the OLED D₁ is changed as the system voltage Vdd is influenced by an IR drop is naturally avoided. Moreover, the current I_{D1} (i.e. I_{OLED1}) neither contains a parameter of the threshold voltage V_{TH, DTFT1} of the transistor DTFT1, so that the current I_{D1} is not changed as the threshold voltage V_{TH, DTFT1} of the transistor DTFT1 is shifted. In other words, brightness of the OLED D₁ lighted by the pixel 100 of the present embodiment does not relate to the threshold voltage V_{TH, DTFT1} of the transistor DTFT1 and the system voltage Vdd.

It should be noticed that the transistor DTFT1, the switches SW1 and SW2 used by the pixel 100 are P-type transistors. However, to achieve the aforementioned functions, in another embodiment, the switch SW2 can also be implemented by a N-type transistor connected as a switch as that shown in a pixel 200 of FIG. 1C. Operation of the pixel 200 of FIG. 1C is substantially the same to that of the pixel 100. In detail, in the pixel 200, the operation of the switch SW2 is inversed to that of the switch SW1, and when the scan signals SCAN1 and SCAN2 are the same, operations of the switch SW1 formed by the P-type transistor and the switch SW2 formed by the N-type transistor are inversed. In an actual application, a same scan line can be used to transmit the same scan signal (for example, the scan signal SCAN1) to the switches SW1 and SW2, so as to enable or disable the switch SW1 when the control signal has the low level or the high level, and enable or disable the switch SW2 when the control signal has the high level or the low level.

Simulation results of the pixel 200 are provided below with reference of figures to further describe the aforementioned deduction. In the following embodiment, the system voltage Vdd is set to 9.5V, and the data voltage V_{data} transmitted by the data line DT is between 1V and 3.5V. Moreover, a channel width-to-length ratio (W/L) of the transistor DTFT1 is 10 um/4 um, and the threshold voltage V_{TH, DTFT1} of the transistor DTFT1 is 1V.

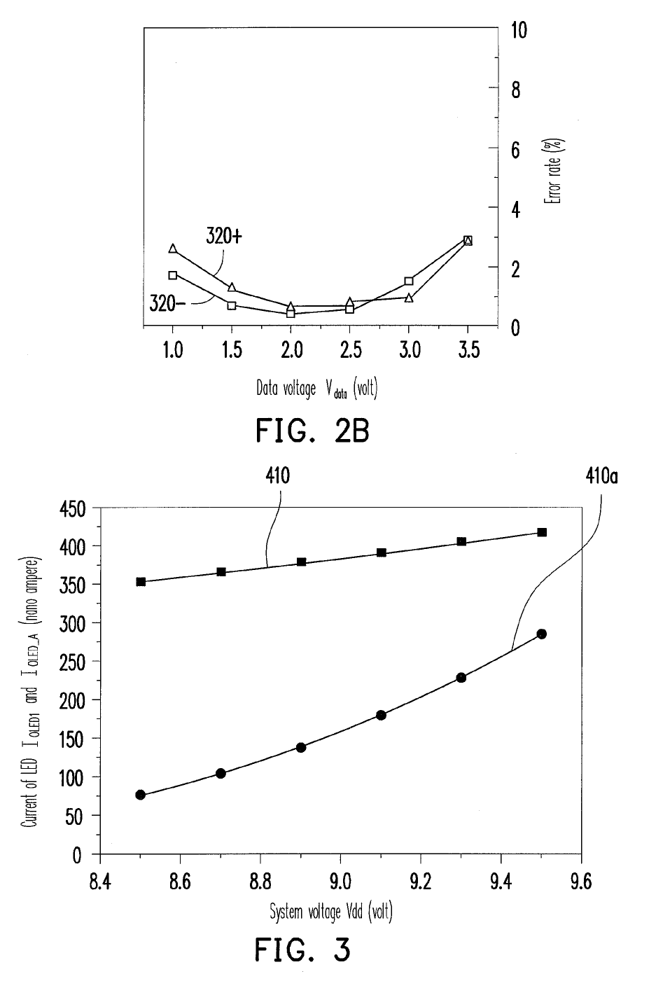

Referring to FIG. 2A, FIG. 2A is a characteristic curve diagram of the current flowing through the OLED and the data voltage transmitted by the data line according to the first embodiment of the present invention. Wherein, a curve 310+ represents a waveform of the current I_{OLED1} of the OLED D₁ when the threshold voltage V_{TH, DTFT1} of the transistor DTFT1 is shifted for +0.33V, a curve 310 represents a waveform of the current I_{OLED1} of the OLED D₁ when the threshold voltage V_{TH, DTFT1} of the transistor DTFT1 is not shifted, and a curve 310− represents a waveform of the current I_{OLED1} of the OLED D₁ when the threshold voltage V_{TH, DTFT1} of the transistor DTFT1 is shifted for −0.33V.

According to FIG. 2A, the curves 310, 310+ and 310− are very close. In other words, even if the threshold voltage V_{TH, DTFT1} of the transistor DTFT1 is shifted for ±0.33V, the current I_{OLED1} of the OLED D₁ is almost not influenced by the shifting of the threshold voltage V_{TH, DTFT1}, and approximately relates to the data voltage V_{data} transmitted by the data line DT.

Further, an error rate ER of the current I_{OLED1} of the OLED D₁ generated when the threshold voltage V_{TH, DTFT1} of the transistor DTFT1 is shifted can be calculated according to an equation (3):

$$ER = \frac{{I}_{OLED 1} ( Δ {V}_{TH , DTFT 1} = \pm 0.33 V ) - {I}_{OLED 1} ( Δ {V}_{TH , DTFT 1} = 0 V )}{{I}_{OLED 1} ( Δ {V}_{TH , DTFT 1} = 0 V )} \qquad ( 3 )$$

Where I_{OLED1}(ΔV_{TH, DTFT1}=÷0.33V) represents the current I_{OLED1} of the OLED D₁ when the threshold voltage V_{TH, DTFT1} of the transistor DTFT1 is shifted for ±0.33V, and I_{OLED1}(ΔV_{TH, DTFT1}=0V) represents the current I_{OLED1} of the OLED D₁ when the threshold voltage V_{TH, DTFT1} of the transistor DTFT1 is not shifted.

FIG. 2B is deduced according to FIG. 2A and the equation (3), wherein two close curves 320+ and 320− respectively represent the error rate ER of the current I_{OLED1} of the OLED D₁ in the pixel 200 that is generated when the threshold voltage V_{TH, DTFT1} of the transistor DTFT1 is shifted for +0.33V and −0.33V. Moreover, in view of specific data, the error rate ER of the current I_{OLED1} of the OLED D₁ in the pixel 200 that is generated when the threshold voltage V_{TH, DTFT1} of the transistor DTFT1 is shifted for ±0.33V is less than 1.5%. The calculated error rate is tiny, which means a relationship between the brightness of the OLED D₁ lighted by the pixel 200 and the threshold voltage V_{TH, DTFT1} of the transistor DTFT1 is tiny, which can be neglected.

On the other hand, assuming the system voltage Vdd has a voltage drop of 1V due to an influence of the IR drop, influences of the system voltage Vdd for a current I_{OLED}_{_{—}}_{A} of an OLED in a conventional pixel using a P-type transistor structure of 2T1C (i.e. two transistors and one capacitor) and the current I_{OLED1} of the OLED D₁ in the pixel 200 of the present embodiment are respectively simulated as curves 410a and 410 of FIG. 3. According to FIG. 3, it is known that the currents I_{OLED}_{_{—}}_{A} of the OLED in the conventional pixel that are influenced by the system voltage Vdd may have a great difference, though the currents I_{OLED1} of the OLED D₁ in the pixel 200 that are influenced by the system voltage Vdd may have a little difference. Therefore, a phenomenon that the current of the OLED in the conventional pixel is changed as the system voltage is influenced by the IR drop can be effectively mitigated.

According to the above descriptions, the present invention further provides a driving method of the pixels 100 and 200 for those with ordinary skill in the art.

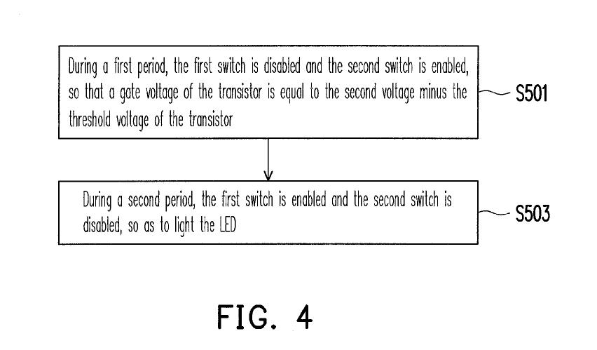

Referring to FIG. 1A and FIG. 4, FIG. 4 is a flowchart illustrating a driving method of the pixel (for example, the pixel 100 or 200) according to the first embodiment of the present invention. First, in step S501, during a first period, the switch SW1 (a first switch) is disabled and the switch SW2 (a second switch) is enabled, so that a gate voltage of the transistor DTFT1 is equal to the second voltage (which is the system voltage Vdd in the present embodiment) minus the threshold voltage of the transistor DTFT1. Next, in step S503, during a second period, the switch SW1 (the first switch) is enabled and the switch SW2 (the second switch) is disabled, so as to light the OLED D₁. Particularly, the brightness of the lighted OLED D₁ is not influenced by the threshold voltage of the transistor DTFT1 and the system voltage Vdd, so that images displayed by a display panel having the pixels 100 and 200 can be more even. Moreover, other details of the driving method are contained in the above embodiment, and therefore detailed descriptions thereof are not repeated.

### Second Embodiment

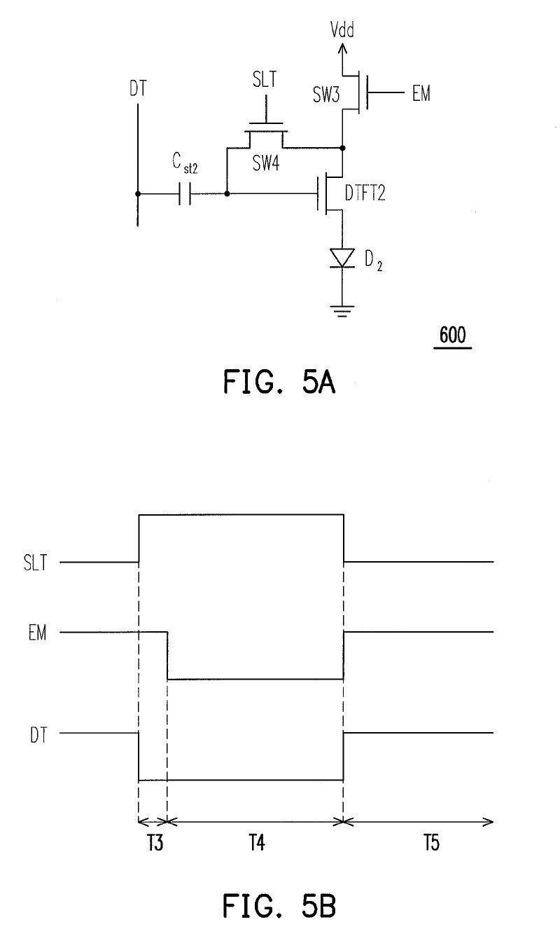

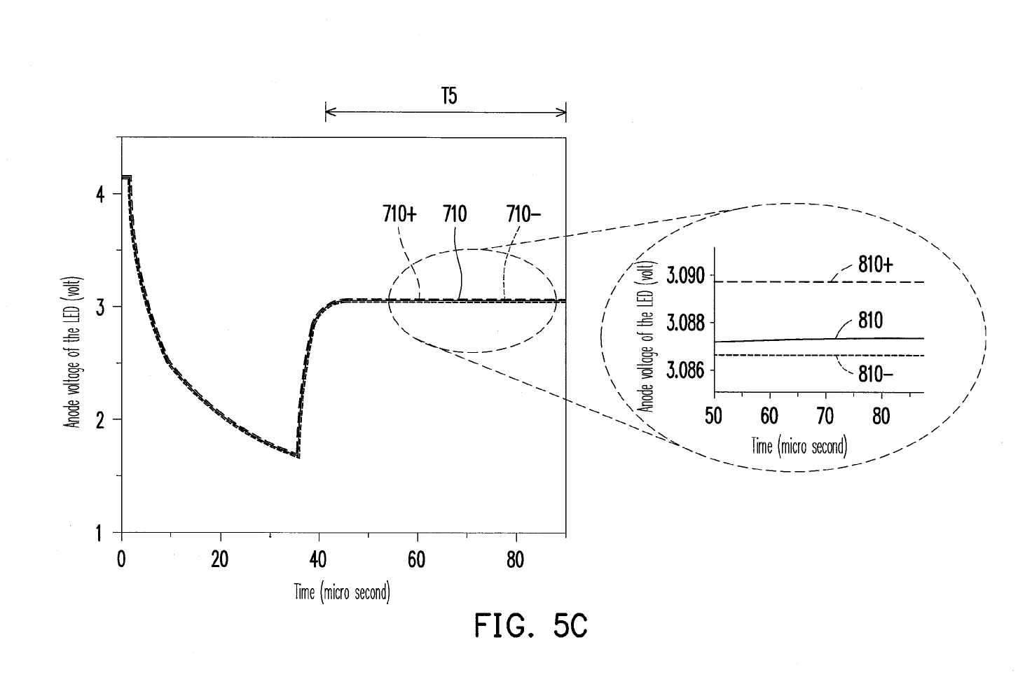

Another embodiment of the pixel of the present invention is provided below, and the concept of the present embodiment is similar to that of the first embodiment, though a main difference there between is that the transistor and the two switches used by the pixel of the present embodiment are all N-type transistors, as that shown in FIG. 5A. The pixel 600 of the present embodiment includes an OLED D₂, an N-type transistor DTFT2, a switch SW3 formed by an N-type transistor, a switch SW4 formed by another N-type transistor, and a capacitor C. It should be noticed that the same or like reference numerals in the present embodiment and the first embodiment denote the same or like elements, and descriptions thereof are not repeated.

A cathode of the OLED D₂ is electrically connected to a first voltage (which is the ground voltage GND in the present embodiment), and a first source/drain of the transistor DTFT2 is electrically connected to a first potential point, for example, an anode of the OLED D₂. The switch SW3 is electrically connected between a second source/drain of the transistor DTFT2 and a second potential point (for example, a second voltage, which is the system voltage Vdd in the present embodiment), and is controlled by a first driving signal, for example, a light-emitting enable signal EM. The switch SW4 is electrically connected between the second source/drain of the transistor DTFT2 and a gate of the transistor DTFT2, and is controlled by a second driving signal, for example, a compensation signal SLT. The capacitor Cₛₜ₂ is electrically connected between the gate of the transistor DTFT2 and a data line DT.

Referring to FIG. 5B for operation of the pixel 600 of the present embodiment, and FIG. 5B is a drive timing diagram of the pixel according to the second embodiment of the present invention. Wherein, the switches SW3 and SW4 are enabled when control signals thereof have a high level, and are disabled when the control signals have a low level.

In the present embodiment, a driving time zone is mainly divided into three periods, and during a period T3, the light-emitting enable signal EM and the compensation signal SLT all have the high level, so that the switches SW3 and SW4 are simultaneously enabled. Meanwhile, a voltage of the data line DT is set to a low level voltage (for example, 0V, so that a left end of the capacitor Cₛₜ₂ is regarded to be electrically connected to the ground voltage). Therefore, the system voltage Vdd can pre-charge the gate of the transistor DTFT2 through the switches SW3 and SW4.

It should be noticed that the gate of the transistor DTFT2 is approximately pre-charged to the system voltage Vdd during the period T3, though considering threshold voltages V_{TH, TFT3} and V_{TH, TFT4} of the switches SW3 and SW4 formed by the N-type transistors, the pre-charged gate voltage of the transistor DTFT2 is substantially equal to the system voltage Vdd minus the two threshold voltages V_{TH, TFT3} and V_{TH, TFT4}, i.e. Vdd−V_{TH, TFT3}−V_{TH, TFT4}. However, since Vdd−V_{TH, TFT3}−V_{TH, TFT4} is very closed to the system voltage Vdd, in the present embodiment, the transistor DTFT2 is regarded to be pre-charged to the system voltage Vdd during the period T3.

Then, after pre-charging of the transistor DTFT2 is completed, during a period T4, the light-emitting enable signal EM is transited to the low level, the compensation signal SLT is maintained to the high level, and the voltage of the data line DT is still set to the low level voltage (for example, 0V). Now, the switch SW3 is disabled, so that the pre-charging path is blocked. On the other hand, the switch SW4 is maintained enabled, so that the gate and the second source/drain of the transistor DTFT2 are mutually coupled to form a diode connection. Therefore, the gate of the transistor DTFT2 that is originally charged to the system voltage Vdd can be discharged to the capacitor Cₛₜ₂ through the switch SW4. Wherein, the gate of the transistor DTFT2 is discharge until a voltage thereof is equal to a threshold voltage V_{TH, DTFT2} of the transistor DTFT2 plus a threshold voltage V_{TH, OLED2} of the OLED D₂, i.e. V_{TH, DTFT2}+V_{TH, OLED2}, and the capacitor Cₛₜ₂ can store this voltage.

Next, during a period T5, the light-emitting enable signal EM is transited to the high level, and the compensation signal SLT is transited to the low level, so that the switch SW3 is enabled and the switch SW4 is disabled. Now, the system voltage Vdd drives the transistor DTFT2 to transmit a current to the OLED D₂ to light the OLED D₂. Meanwhile, the data line DT transmits data to the capacitor Cₛₜ₂. Therefore, according to a boost effect, the capacitor Cₛₜ₂ can boost the gate voltage of the transistor DTFT2 from an original voltage equal to a sum of the threshold voltages of the transistor DTFT2 and the OLED D₂ (V_{TH, DTFT2}+V_{TH, OLED2}) to the data voltage V_{data} transmitted by the data line DT plus the sum of the threshold voltages of the transistor DTFT2 and the OLED D₂ (V_{TH, DTFT2}+V_{TH, OLED2}), i.e. V_{data}+V_{TH, DTFT2}+V_{TH, OLED2}.

Since the transistor DTFT2 is maintained in the saturation area, a current I_{D2} flowing through the OLED D₂ is calculated according to a following equation:

$$\begin{matrix}{I}_{D 2} = \frac{1}{2} {{K}_{DTFT 2} ( {V}_{GS , DTFT 2} - {V}_{TH , DFT 2} )}^{2} \\ = \frac{1}{2} {{K}_{DTFT 2} ( ( \begin{matrix}{V}_{data} + {V}_{TH , DTFT 2} + \\ {V}_{TH , OLED 2} - {V}_{TH , OLED 2}\end{matrix} ) - {V}_{TH , DTFT 2} )}^{2}\end{matrix} \qquad ( 4 )$$

Where I_{D2} is the current flowing through the OLED D₂ (i.e. I_{OLED2}), V_{GS, DTFT2} is a gate-source voltage of the transistor DTFT2, and K_{DTFT2} is a current constant of the transistor DTFT2. Moreover, the equation (4) can be further modified to be an equation (5):

$${I}_{D 2} = \frac{1}{2} {{K}_{DTFT 2} ( {V}_{data} )}^{2} \qquad ( 5 )$$

According to the equations (4) and (5), it is known that the gate-source voltage V_{GS, DTFT2} of the transistor DTFT2 does not contain a parameter of the threshold voltage V_{TH, OLED2} of the OLED D₂, and the current I_{D2} (i.e. I_{OLED2}) flowing through the OLED D₂ does not contain the parameter of the threshold voltage V_{TH, OLED2} of the OLED D₂. Moreover, the current I_{D2} (i.e. I_{OLED2}) neither contains the parameter of the threshold voltage V_{TH, DTFT2} of the transistor DTFT2. In other words, brightness of the OLED D₂ lighted by the pixel 600 of the present embodiment does not relate to the threshold voltages V_{TH, OLED2} of the OLED D₂ and V_{TH, DTFT2} of the transistor DTFT2.

Simulation results of the pixel 600 are provided below with reference of figures to further describe the aforementioned deduction. In the following embodiment, the system voltage Vdd is set to 10V, and a voltage value of the light-emitting enable signal EM or the compensation signal SLT having the high level is 15V. Moreover, a channel width-to-length ratio of the transistor DTFT2 is 20 um/2 um.

Referring to FIG. 5C, FIG. 5C is a diagram illustrating a simulation result of voltage variation at the anode of the OLED according to the second embodiment of the present invention. Wherein, the data voltage V_{data} transmitted by the data line DT in the pixel 600 is, for example, 3V to obtain three curves of 710+, 710− and 710. The curve 710+ represents a voltage waveform of the anode of the OLED D₂ when the threshold voltage V_{TH, DTFT2} of the transistor DTFT2 is shifted for +0.33V, the curve 710 represents a voltage waveform of the anode of the OLED D₂ when the threshold voltage V_{TH, DTFT2} of the transistor DTFT2 is not shifted, and a curve 710− represents a voltage waveform of the anode of the OLED D₂ when the threshold voltage V_{TH, DTFT2} of the transistor DTFT2 is shifted for −0.33V.

According to FIG. 5C, the curves 710, 710+ and 710− are very close, and during the period T5 (i.e. a lighting period of the OLED D₂), the anode voltage of the OLED D₂ is approximately between 3.086V and 3.090V. In other words, even if the threshold voltage V_{TH, DTFT2} of the transistor DTFT2 is shifted for ±0.33V, the anode voltage of the OLED D₂ is almost not influenced by the shifting of the threshold voltage V_{TH, DTFT2}.

Further, an error rate ER of the anode voltage of the OLED D₂ generated when the threshold voltage V_{TH, DTFT2} of the transistor DTFT2 is shifted can be calculated according to an equation (6):

$$ER = \frac{{V}_{OLED 2} ( Δ {V}_{TH , DTFT 2} = \pm 0.33 V ) - {V}_{OLED 2} ( Δ {V}_{TH , DTFT 2} = 0 V )}{{V}_{OLED 2} ( Δ {V}_{TH , DTFT 2} = 0 V )} \qquad ( 6 )$$

Where V_{OLED2}(ΔV_{TH, DTFT2}=±0.33V) represents the anode voltage V_{OLED2} of the OLED D₂ when the threshold voltage V_{TH, DTFT2} of the transistor DTFT2 is shifted for ±0.33V, and V_{OLED2}(ΔV_{TH, DTFT2}=0V) represents the anode voltage V_{OLED2} of the OLED D₂ when the threshold voltage V_{TH, DTFT2} of the transistor DTFT2 is not shifted.

According to FIG. 5C and the equation (6), it can be calculated that the error rate generated when the threshold voltage V_{TH, DTFT2} is shifted for +0.33V is 0.021%, and the error rate generated when the threshold voltage V_{TH, DTFT2} is shifted for −0.33V is 0.081%, i.e. the error rate is between 0.021% and 0.081%. The calculated error rate is tiny, which means a relationship between the brightness of the OLED D₂ lighted by the pixel 600 and the threshold voltage V_{TH, DTFT2} of the transistor DTFT2 is tiny, which can be neglected.

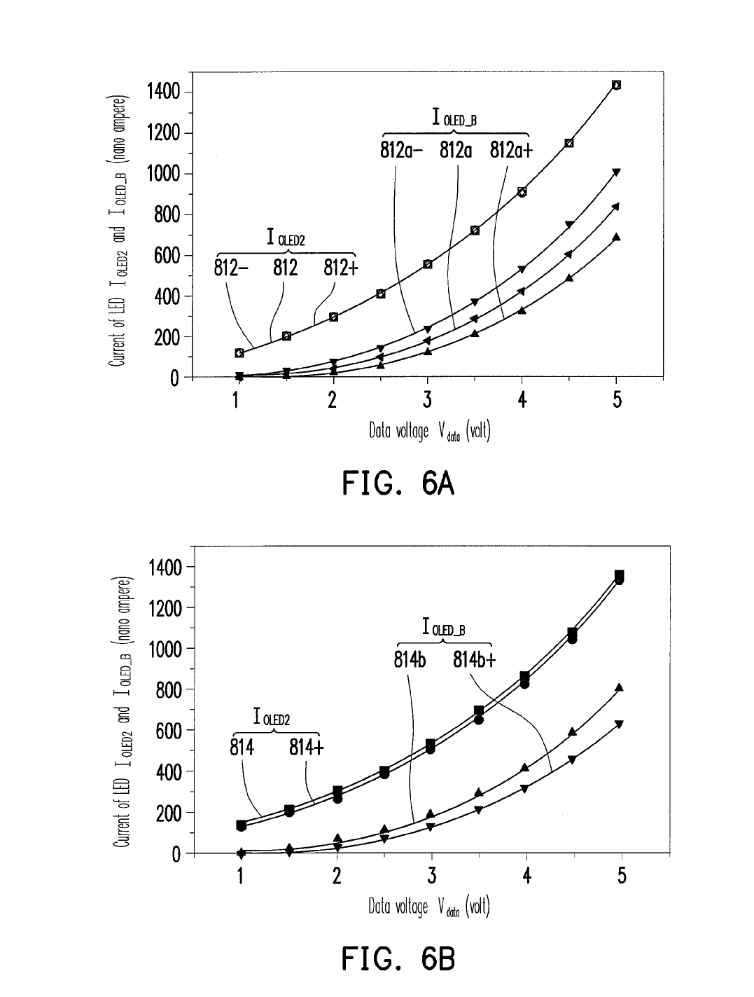

Referring to FIG. 6A, FIG. 6A is a characteristic curve diagram of the currents I_{OLED2} and I_{OLED}_{_{—}}_{B} flowing through the OLED D₂ and the OLED of the conventional pixel applying the N-type transistor structure of 2T1C, and the data voltage V_{data} transmitted by the data line DT according to the second embodiment of the present invention. Wherein, curves 812−, 812 and 812+ respectively represent a waveform of the current I_{OLED2} of the OLED D₂ when the threshold voltage V_{TH, DTFT2} of the transistor DTFT2 in the pixel 600 is shifted for −0.33V, not shifted and shifted for +0.33V, and curves 812a−, 812a and 812a+ respectively represent a waveform of the current I_{OLED}_{_{—}}_{B} of the OLED in the conventional pixel when the threshold voltage of the transistor is shifted for −0.33V, not shifted and shifted for +0.33V.

According to FIG. 6A, the three separated curves 812a−, 812a and 812a+ denote that the OLED in the conventional pixel that is influenced by the shifting of the threshold voltage of the transistor can generate the currents I_{OLED}_{_{—}}_{B} with great differences. However, the curves 812−, 812 and 812+ are almost overlapped, which means shifting of the threshold voltage V_{TH, DTFT2} of the transistor DTFT2 hardly influences the current I_{OLED2} of the OLED D₂.

According to another aspect, as shown in FIG. 6B, FIG. 6B is another characteristic curve diagram of the currents I_{OLED2} and I_{OLED}_{_{—}}_{B} flowing through the OLED D₂ and the OLED of the conventional pixel applying the N-type transistor structure of 2T1C, and the data voltage V_{data} transmitted by the data line DT according to the second embodiment of the present invention. Wherein, curves 814 and 814+ respectively represent a waveform of the current I_{OLED2} of the OLED D₂ when the threshold voltage V_{TH, OLED2} of the OLED D₂ in the pixel 600 is not shifted and is shifted for +0.33V, and curves 814b and 814ba+ respectively represent a waveform of the current I_{OLED}_{_{—}}_{B} of the OLED when the threshold voltage of the OLED in the conventional pixel is not shifted and is shifted for +0.33V.

Accordingly, the curves 814b and 814b+ denote that the OLED in the conventional pixel that is influenced by the shifting of the threshold voltage of the transistor can generate the currents I_{OLED}_{_{—}}_{B} with great differences. However, the curves 814 and 814+ are almost the same, so that shifting of the threshold voltage V_{TH, OLED2} of the OLED D₂ hardly influences the current I_{OLED2} of the OLED D₂.

According to the above descriptions, the present invention further provides a driving method of the pixel 600 for those with ordinary skill in the art.

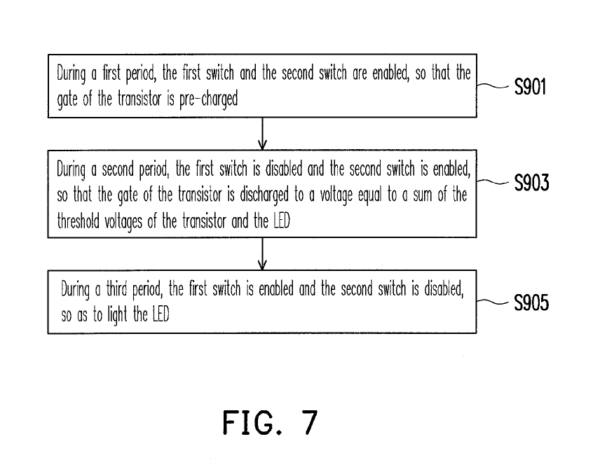

Referring to FIG. 5A and FIG. 7, FIG. 7 is a flowchart illustrating a driving method of the pixel 600 according to the second embodiment of the present invention. First, in step S901, during a first period, the switch SW3 (the first switch) and the switch SW4 (the second switch) are enabled, so that the gate of the transistor DTFT2 is pre-charged. Next, in step S903, during a second period, the switch SW3 (the first switch) is disabled and the switch SW4 (the second switch) is enabled, so that the gate of the transistor DTFT2 is discharged to a voltage equal to a sum of the threshold voltages of the transistor DTFT2 and the OLED D₂. Next, in step S905, during a third period, the switch SW3 (the first switch) is enabled and the switch SW4 (the second switch) is disabled, so as to light the OLED D₂. Particularly, the brightness of the lighted OLED D₂ is not influenced by the threshold voltages of the transistor DTFT2 and the OLED D₂, so that a display panel having the pixels 600 may have a better display quality. Moreover, other details of the driving method are contained in the above embodiment, and therefore detailed descriptions thereof are not repeated.

It should be noticed that the pixels 100, 200 and 600 can also be applied for organic light-emitting illumination applications. To be specific, each of the pixels 100, 200 and 600 can be used as a light-emitting unit (not shown) and applied to an illuminating device (not shown), wherein an illuminating brightness of the illuminating device can be adjusted by adjusting a voltage value. Therefore, problems of inconsistency of the threshold voltage of the conventional transistor and attenuation of a function of the OLED as the using time thereof increases can be resolved, so that illuminating quality of the illuminating device can be improved.

It should be noticed that in the above embodiments, the OLED is used for descriptions, though the present invention is not limited thereto, and a polymer light emitting diode (polymer LED, PLED) can also be used in the aforementioned pixels.

In summary, according to the driving method of the present invention and an ingenious arrangement of the components in the pixel of the present invention, the brightness of the OLED in the pixel can be irrelevant to the threshold voltage of the transistor used for driving the OLED, so that the brightness of the OLED is not changed even if the threshold voltage of the transistor is shifted. Moreover, a phenomenon that the brightness of the OLED is changed as the threshold voltage thereof is shifted and a phenomenon that the brightness of the OLED is changed as the system voltage is influenced by the IR drop can be effectively mitigated, so that the display panel having the pixel of the present invention may have a better display quality. In addition, the pixel of the present invention can also be applied for organic light-emitting illumination applications, and with functions of compensating inconsistency of the threshold voltage of the conventional transistor and attenuation of the OLED as the using time thereof increases, according to this patent, not only theses shortages can be compensated, but also illuminating brightness of the illuminating device can be adjusted according to different voltages.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel, comprising:
an organic light-emitting diode (OLED), having one end electrically connected to a first voltage;
a transistor, having a first source/drain electrically connected to a first potential point;
a first switch, electrically connected between a second source/drain of the transistor and a second potential point, and controlled by a first driving signal;
a second switch, electrically connected between the second source/drain of the transistor and a gate of the transistor, and controlled by a second driving signal; and
a capacitor, electrically connected between the gate of the transistor and a data line,
wherein the first driving signal and the second driving signal are used to alternately enable/disable the first and the second switches, so as to drive the pixel.

2. The pixel as claimed in claim 1, wherein the first potential point is another end of the OLED; the second potential point is a second voltage; the first driving signal is a light emitting enable signal; and the second driving signal is a compensation signal.

3. The pixel as claimed in claim 2, wherein when the compensation signal and the light-emitting enable signal simultaneously enable the second switch and the first switch, the gate of the transistor is pre-charged to a voltage closed to the second voltage; and a voltage of the data line is a low level voltage.

4. The pixel as claimed in claim 2, wherein the first switch is a first transistor, and the second switch is a second transistor.

5. The pixel as claimed in claim 4, wherein when the compensation signal and the light-emitting enable signal simultaneously enable the second transistor and the first transistor, the gate of the transistor is pre-charged to a voltage equal to the second voltage minus threshold voltages of the first and the second transistors; and a voltage of the data line is a low level voltage.

6. The pixel as claimed in claim 2, wherein when the compensation signal enables the second switch and the light-emitting enable signal disables the first switch, the gate of the transistor is discharged to a voltage equal to a sum of a threshold voltage of the transistor and a threshold voltage of the OLED; and a voltage of the data line is a low level voltage.

7. The pixel as claimed in claim 2, wherein when the compensation signal disables the second switch and the light-emitting enable signal enables the first switch, a voltage of the gate of the transistor is boosted to a voltage of the data line plus threshold voltages of the transistor and the OLED.

8. The pixel as claimed in claim 2, wherein the transistor, the first switch and the second switch are N-type transistors.

9. The pixel as claimed in claim 2, wherein the first voltage is a ground voltage, and the second voltage is a system voltage.

10. The pixel as claimed in claim 1, wherein the first potential point is a second voltage; the second potential point is another end of the OLED; the first driving signal is a first scan signal; and the second driving signal is a second scan signal.

11. The pixel as claimed in claim 10, wherein when the first scan signal disables the first switch and the second scan signal enables the second switch, a gate voltage of the transistor is equal to the second voltage minus a threshold voltage of the transistor.

12. The pixel as claimed in claim 10, wherein when the first scan signal enables the first switch and the second scan signal disables the second switch, a gate voltage of the transistor is equal to the second voltage minus a threshold voltage of the transistor and a voltage of the data line formed when the first switch is disabled and the second switch is enabled.

13. The pixel as claimed in claim 10, wherein the first scan signal is inverted to the second scan signal.

14. The pixel as claimed in claim 13, wherein the transistor, the first switch and the second switch are P-type transistors.

15. The pixel as claimed in claim 10, wherein the first scan signal is the same to the second scan signal.

16. The pixel as claimed in claim 15, wherein the transistor and the first switch are P-type transistors; and the second switch is an N-type transistor.

17. The pixel as claimed in claim 10, wherein the first voltage is a ground voltage, and the second voltage is a system voltage.

18. An illuminating device, comprising:
at least a light-emitting unit, comprising:
an organic light-emitting diode (OLED), having one end electrically connected to a first voltage;
a transistor, having a first source/drain electrically connected to a first potential point;
a first switch, electrically connected between a second source/drain of the transistor and a second potential point, and controlled by a first driving signal;
a second switch, electrically connected between the second source/drain of the transistor and a gate of the transistor, and controlled by a second driving signal; and
a capacitor, electrically connected between the gate of the transistor and a data line,
wherein the first driving signal and the second driving signal are used to alternately enable/disable the first and the second switches, so as to drive the pixel.

19. The illuminating device as claimed in claim 18, wherein the first potential point is another end of the OLED; the second potential point is a second voltage; the first driving signal is a light emitting enable signal; and the second driving signal is a compensation signal.

20. The illuminating device as claimed in claim 18, wherein first potential point is a second voltage; the second potential point is another end of the OLED; the first driving signal is a first scan signal; and the second driving signal is a second scan signal.
